(19) United States
(12) Patent Application Publication
(10) Pub. No.: US 2021/0345548 A1
(43) Pub. Date: Nov. 11, 2021

(54) Bracket System for Optional Sweeping Accessory for Lawn Mower and Method of Use Thereof

(71) Applicant: Frank Hwang, San Jose, CA (US)

(72) Inventor: Frank Hwang, San Jose, CA (US)

(21) Appl. No.: 16/872,249

(22) Filed: May 11, 2020

(51) Int. Cl. A01D 42/06; A01G 20/43; A46B 3/08

(52) U.S. Cl. CPC A01D 42/06; A01D 2101/00; A46B 3/08; A01G 20/43

(57) ABSTRACT

A bracket system for attaching a brush to the blades of a rotary lawn mower. The bracket system has a brush attachment, at least one clamp, and a fastening device. The brush attachment has a brush, an elongated vertical slot, and a flange. The at least one clamp is placed around a non-linear lawn mower blade and is secured to the flange by the fastening device. Securing the clamp to the flange by the fastening device secures the brush attachment to the non-linear mower blade. Securing or removing the fastening device allows the attachment or removal of the brush attachment from the clamps, and thus the non-linear mower blade.

### FIELD OF THE INVENTION

The present invention relates generally to a bracket system for attaching a brush to the blades of a rotary lawn mower.

### BACKGROUND OF THE INVENTION

Rotary lawn mowers are well known powered machines for cutting vegetation using a rotating blade or blades. Rotary lawn mowers use a horizontal blade or multiple horizontal blades which rotate around a central axis to cut vegetation, such as grass. The horizontal blades rotate parallel to the ground, and cut the vegetation to a uniform length.

When using a rotary lawn mower to cut vegetation, some additional objects may interfere with the cutting of the vegetation. For example, snow or leaves may need to be swept out of the way before the vegetation can be cut. To solve this, there is a need for a brush attachment to the blades of a rotary lawn mower to sweep away these objects that can interfere with the cutting of the vegetation. There also is a desire to add functionality to a lawn mower to permit it to be used to sweep surfaces such as driveways and sidewalks.

Brush attachments to rotary lawn mowers are known in the art. For example, U.S. Pat. No. 3,048,869 to Beatty discloses a brush attachment for rotary mowers. Beatty discloses a brush attachment that is shaped like a separate blade, which is secured above the cutter blade. The brush attachment has two brushes at either end of the brush attachment, and is secured to the rotary mower by removing the cutter blade, inserting the brush attachment to the center bolt that holds the cutter blade, then replacing and securing the cutter blade. One significant issue with this attachment is that it is not easily removable, which is a significant drawback when the user wants to switch back and forth between the sweeping and cutting functions. Additionally, the Beatty brush consumes greater resources because the attachment means utilizes an unnecessary amount of material to attach a small brush to the rotary mower.

There is a need for a brush attachment for a rotary lawn mower that is easily attachable and removable. Additionally, there is a need for a brush attachment that is compact in size and easy to use.

### SUMMARY OF THE INVENTION

The present invention relates to a bracket system for attaching a brush to the blades of a rotary lawn mower. It is an object of the invention to provide a bracket system that allows for the easy installation and removal of a brush to the blade of a lawn mower. It is another object of the invention to provide a bracket system for attaching a brush to the blades of a rotary lawn mower that is compact in size, and does not require the disassembling of the lawn mower blade to be attached. It is another object of the invention to provide a bracket system for attaching a brush to common non-linear mower blades readily available on the market without alteration to the blade.

The bracket system has a brush attachment. The brush attachment has a brush, an elongated vertical slot, and a flange. The bracket system also has at least one clamp and a fastening device. The at least one clamp is placed around a non-linear lawn mower blade and is secured to the flange by the fastening device. Securing the clamp to the flange by the fastening device secures the brush attachment to the non-linear mower blade. Securing or removing the fastening device allows the attachment or removal of the brush attachment from the clamps, and thus the non-linear mower blade.

### BRIEF DESCRIPTION OF THE DRAWINGS

These and other features and advantages of the present invention will become appreciated, as the same becomes better understood with reference to the specification, claims and drawings herein:

FIG. 1 is a bottom view of a rotary lawn mower with a bracket system for attaching a brush to the blades of the rotary lawn mower secured to the mower blade according to a first embodiment.

FIG. 2 is a side view of a rotary lawn mower with the bracket system for attaching a brush to the blades of the rotary lawn mower secured to the mower blade according to a first embodiment.

FIG. 3 is a bottom perspective view of the bracket system for attaching a brush to the blades of a rotary lawn mower secured to a non-linear mower blade according to a first embodiment.

FIG. 4 is a side view of the bracket system for attaching a brush to the blades of a rotary lawn mower secured to the non-linear mower blade according to a first embodiment.

FIG. 5 is a bottom perspective view of the bracket system for attaching a brush to the blades of a rotary lawn mower detached from the non-linear mower blade according to a first embodiment.

FIG. 6 is a side view of the bracket system for attaching a brush to the blades of a rotary lawn mower secured to the non-linear mower blade according to a second embodiment.

FIG. 7 is a side view of the bracket system for attaching a brush to the blades of a rotary lawn mower secured to the non-linear mower blade according to a third embodiment.

FIG. 8 is a side view of the bracket system for attaching a brush to the blades of a rotary lawn mower secured to the non-linear mower blade according to a fourth embodiment.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” and “inner” or “outer,” may be used herein to describe one element's relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

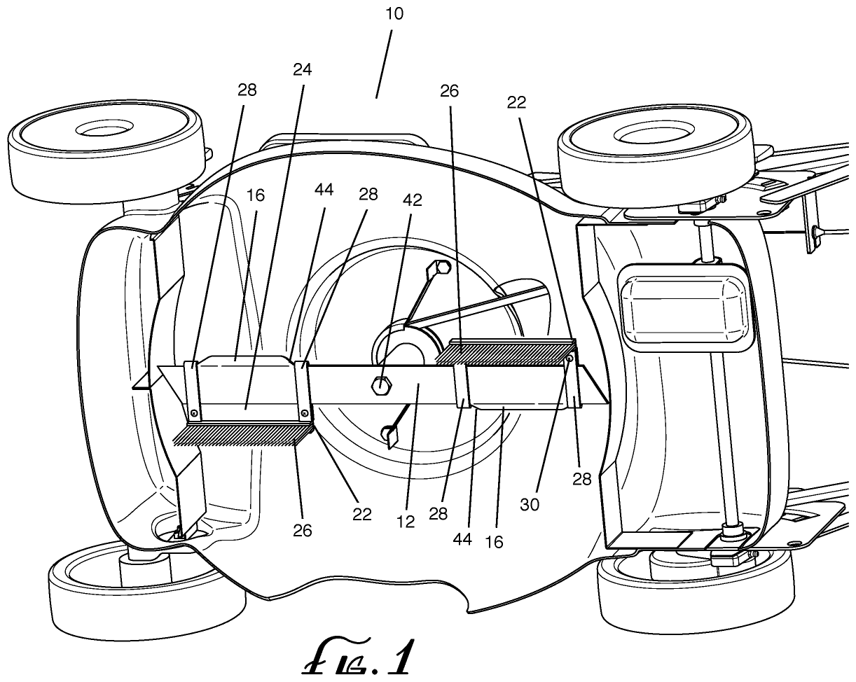

A bracket system for attaching a brush to the blade of a lawn mower is provided. FIGS. 1-5 depict the preferred embodiment of the bracket system 20 and how the bracket system 20 is removably secured to a non-linear mower blade 12 of a rotary lawn mower 10. A non-linear mower blade 12 is defined as a mower blade having an elongated edge in which a portion of said edge is defined by a protrusion, an indentation, and/or a projection out of the plane of the blade. As depicted in FIGS. 1-5, the bracket system 20 includes a brush attachment 21. The brush attachment 21 includes a brush 26, an elongated vertical slot 22, and a flange 24. The bracket system 20 also includes at least one clamp 28 and a fastening device. At least one clamp 28 surrounds a non-linear mower blade 12 and is secured to the brush attachment 21 by inserting the flange 24 into the at least one clamp 28 and securing the at least one clamp 28 to the flange 24. The flange 24 is fixed to the elongated vertical slot 22, which holds the brush 26. Attaching the at least one clamp 28 to the flange 24 of the brush attachment 21 secures the brush attachment 21 to the non-linear mower blade 12, thereby attaching the bracket system 20 to a rotary lawn mower 10.

In the preferred embodiment, the bracket system 20 is utilized to attach a brush attachment 21 to a non-linear mower blade 12. The brush attachment 21 includes the brush 26, elongated vertical slot 22, and the flange 24. The brush 26 extends downward from the elongated vertical slot 22, preferably to the surface of the ground. In the preferred embodiment, the brush 26 is made up of a plurality of bristles made of nylon. Alternate bristle materials may be utilized to make up the brush 26 without departing from the concepts disclosed herein.

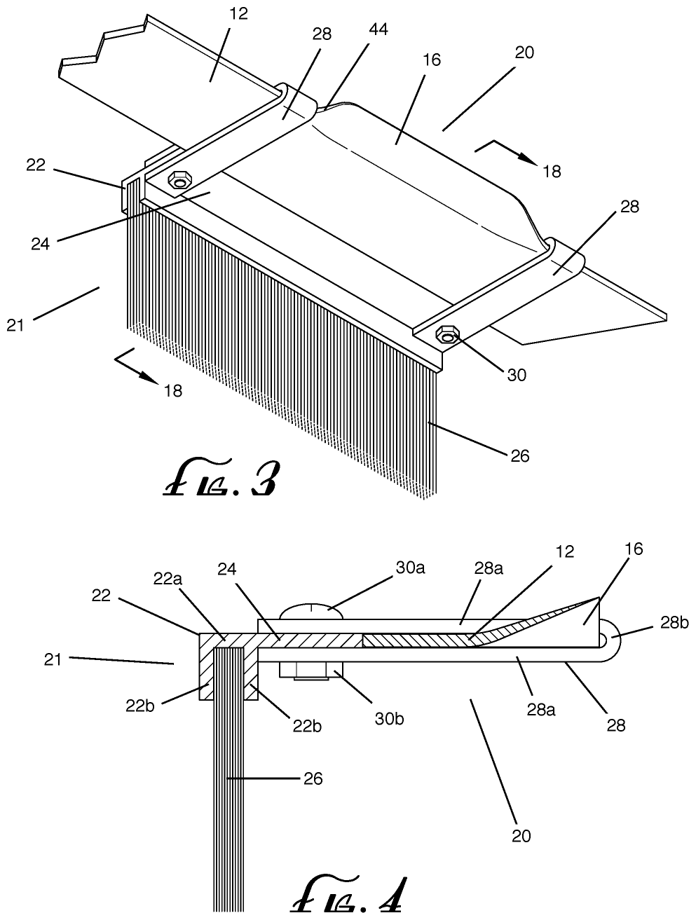

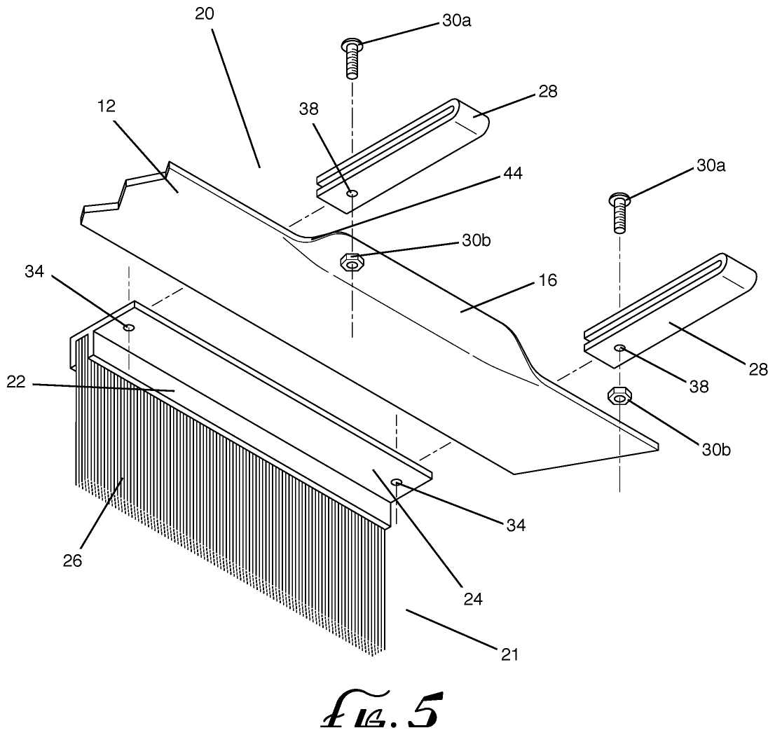

The elongated vertical slot 22 secures the brush 26 to the brush attachment 21. As shown in FIGS. 4-5, the elongated vertical slot 22 is characterized by an elongated horizontal base 22a with two vertical legs 22b extending downward from the elongated horizontal base 22a. The top portion of the brush 26 sits between the two vertical legs 22b of the elongated vertical slot 22 and is affixed to the elongated horizontal base 22a. The brush 26 is affixed to the elongated horizontal base 22a by attaching the bristles of the brush 26 to the elongated horizontal base 22a between the two vertical legs 22b. In other embodiments, the brush 26 is affixed to the elongated vertical slot 22 by crimping the two vertical legs 22b together. Alternatively, other ways of affixing the brush 26 to the elongated vertical slot 22 may be utilized without departing from the spirit of the invention.

Fixed to the elongated vertical slot 22 is a flange 24. In the preferred embodiment, the flange 24 extends from the elongated vertical slot 22 on the same plane as the elongated horizontal base 22a. But the flange 24 is not require to be in the same plane as the elongated horizontal base 22a, but rather the flange 24 could be secured to the elongated vertical slot 22 at different positions on one of the vertical legs 22b. The flange 24 may either be attached to the elongated vertical slot 22, or the flange 24 and elongated vertical slot 22 may be manufactured out of a single piece of material. The flange 24 is configured to be inserted and fit inside the clamp 28 when the brush attachment 21 is secured to the non-linear mower blade 12.

Preferably, the flange 24 includes at least one flange aperture 34. The at least one flange aperture 34 is configured to align with the clamp apertures 38 of the at least one clamp 28. The end of the flange 24 opposing the elongated vertical slot 22 is the same depth as the non-linear mower blade 12, such that the top and bottom of the flange 24 sits flush with the top and bottom of the non-linear mower blade 12 when the flange 24 contacts the non-linear mower blade 12. The flush top and bottom surface of the flange 24 and non-linear mower blade 12 provide a flat and flush surface to be inserted into the clamp 28.

The clamp 28 is configured to surround the non-linear mower blade 12 and secure the brush attachment 21 to the non-linear mower blade 12 by removably attaching to the flange 24. In the preferred embodiment shown in FIGS. 1-5, two clamps 28 are configured to surround the non-linear mower blade 12 and are secured to the flange 24 of the brush attachment 21 by a fastening device. While two clamps are used in the preferred embodiment, other embodiments may utilize a single clamp or a plurality of clamps.

The clamp 28 is generally c-shaped, characterized by two clamp legs 28a extending from a rounded base 28b. The length of each clamp leg 28a is greater than the width of the non-linear mower blade 12, such that when the clamp 28 is placed around a non-linear mower blade 12, a portion of each clamp leg 22a extends beyond the non-linear mower blade 12. The gap between each clamp leg 28a is greater than or equal to the depth of the non-linear mower blade 12 and the flange 24. Preferably the clamp 28 is made of a malleable material such that the gap between each clamp leg 28a may be greater than the depth of the non-linear mower blade 12 and the flange 24 when placing the clamp 28 around the non-linear mower blade 12, and equal to the depth of the non-linear mower blade 12 and the flange 24 when securing the clamp 28 to the non-linear mower blade 12. While the preferred shape of the clamp 28 is disclosed in detail, other shapes may be used without departing from the spirit of the invention so long as the clamp sufficiently surrounds the non-linear mower blade 12.

Located in the portion of each clamp leg 22a that extends beyond the non-linear mower blade 12 is a clamp aperture 38. Each respective clamp leg 28a of each clamp 28 includes a clamp aperture 38. The clamp apertures 38 align with the flange aperture 34 the flange 24 contacts the side of the non-linear mower blade 12 and the flange 24 and the non-linear mower blade 12 are inserted into the clamp 28. The alignment of the clamp apertures 38 and the flange aperture 34 allow a fastening device to secure the clamp 28 to the flange 24, thus securing the brush attachment 21 to the non-linear mower blade 12.

In the preferred embodiment, a bolt and nut 30 are utilized as the fastening device to secure the clamp 28 to the flange 24, thereby securing the brush attachment 21 to the non-linear mower blade 12. The bolt 30a is placed through the clamp apertures 38 and the flange aperture 34. The nut 30b is then screwed onto the bolt 30a, thereby securing the clamp 28 to the flange 24. While the preferred fastening device is a bolt and nut 30, other fastening devices may be utilized without departing from the spirit of the invention. For example, the second clamp aperture 38 may be threaded such that only a bolt 30a is needed to secure the clamp 28 to the flange 24. Alternatively, other methods of fastening the clamp 28 to the flange 24 without the need for the apertures are contemplated as well.

Tightening the bolt and nut 30 secures the clamp 28 to the flange 24 of the brush attachment 21, which thereby attaches the bracket system 20 to the non-linear mower blade 12. The bolt and nut 30 may be loosened and removed subsequently to remove the brush attachment 21 from the non-linear mower blade 12. Thus, the bracket system 20 is removable from the non-linear mower blade 12 such that the brush attachment 21 may be easily attached to or removed from the rotary lawn mower 10.

An alternative embodiment of securing the brush attachment 21 to the clamp 28, thereby attaching the bracket system 20 to the non-linear mower blade 12, is shown in FIG. 6. In this alternate embodiment, the flange 24 is configured to overlap the non-linear mower blade 12 when the bracket system 20 is attached to the non-linear mower blade 12. The flange aperture is positioned closer to the elongated vertical slot 22 than the opposing end of the flange 24. The flange aperture is located on the portion of the flange 24 that does not overlap the non-linear mower blade 12. The clamp apertures are positioned near the end of the clamp 28. The location of the flange aperture and clamp apertures are configured to align and permit a bolt 30a to be placed through the clamp apertures and flange apertures without being placed through the non-linear mower blade 12. When the bolt 30a is placed through the clamp apertures and flange aperture, the non-linear mower blade 12 abuts the bolt 30a. Tightening the nut 30b onto the bolt 30a removably secures the flange 24 to the clamp 28, thereby removably attaching the bracket system 20 to the non-linear mower blade 12.

FIG. 1 depicts the preferred embodiment of the bracket system 20 secured to a non-linear mower blade 12 of a rotary lawn mower 10, as shown from the bottom of the rotary lawn mower 10. In this embodiment, the bracket system 20 is attached to both portions of the non-linear mower blade 12 extending radially from the center point 42 of the non-linear mower blade 12. The bracket system 20 does not require modification to the non-linear mower blade 12, and is easily attached or removed as previously discussed. As shown in FIGS. 1 and 4, the non-linear mower blade 12 is characterized by a protrusion 16 extending outward and upward from the non-linear mower blade 12. This configuration of a non-linear mower blade 12 is utilized for exemplary purposes, as other configurations and shapes of non-linear mower blades may be utilized without departing from the concepts disclosed.

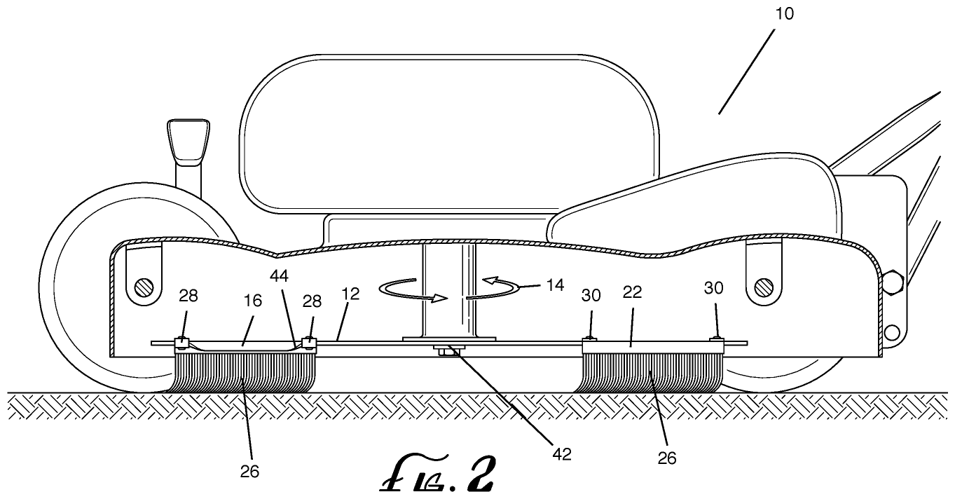

For the exemplary configuration of the non-linear mower blade 12, the bracket system 20 utilizes two clamps 28 which are positioned on each side of the protrusion 16. Each clamp 28 is secured to the flange 24 by the bolt and nut 30, thereby attaching the bracket system 20 to the non-linear mower blade 12. In the embodiment shown in FIGS. 2-3, the clamp 28 closest to the center point 42 of rotation of the blade 12 on the interior side of the protrusion 16 allows the clamp 28 to resist the centrifugal force 18 of the rotating blade 12 because the protrusion 16 provides a bracing surface 44 for the clamp 28 to brace against, thereby holding the bracket system 20 in place when the blade 12 rotates during operation of the lawn mower.

FIG. 2 depicts the preferred embodiment of the bracket system 20 secured to a non-linear mower blade 12 of a rotary lawn mower 10, as shown from the side of the rotary lawn mower 10. The rotation 14 of the non-linear mower blade 12 permits the brush 26 to contact and be moved across the ground while the bracket system 20 stays secured to the non-linear mower blade 12.

FIG. 3 depicts the preferred embodiment of the bracket system 20 secured to a non-linear mower blade 12, as viewed from the bottom perspective. The two clamps 28 are secured to the flange 24, thereby securing the brush attachment 21 to the non-linear mower blade 12. Each clamp 28 sits on one side of the protrusion 16 of the non-linear mower blade 12. When the non-linear mower blade 12 is rotating, the non-linear mower blade 12 and bracket system 20 undergo centrifugal forces 18. The protrusion 16 of the non-linear mower blade 12 prevents the bracket system 20 from sliding off the non-linear mower blade 20 due to the centrifugal forces 18.

While this configuration of a non-linear mower blade 12 with the protrusion 16 is used for exemplary purposes, other configurations of non-linear mower blades may be utilized so long as at least one clamp 28 is positioned such that at least one clamp 28 sits adjacent to the non-linear portion of a non-linear mower blade 12. For example, a blade 12 could be used that has an indentation along its edge. The clamps 28 can be secured within the indentation in order to provide a bracing surface 44 for at least one of the clamps 28 to resist the centrifugal force 18 caused by the rotation 14 of the non-linear mower blade 12.

FIG. 4 depicts the preferred embodiment of the bracket system 20 secured to a non-linear mower blade 12, as viewed from the side. The protrusion 16 of the non-linear mower blade 12 extends outward and upward from the non-linear mower blade 12, such that the clamp 28 cannot slide off the non-linear mower blade 12 under centrifugal forces 18. The clamp 28 surrounds the non-linear mower blade 12 adjacent to the protrusion 16 and is attached to the flange 24 by the bolt 30a and nut 30b. The brush attachment 21 is therefore removably secured to the non-linear mower blade 12.

FIG. 5 depicts the preferred embodiment of the bracket system 20 detached from the non-linear mower blade 12, as viewed from the bottom perspective. In the preferred embodiment, the brush attachment 21 is separated from the clamps 28 and fastening device. The elongated vertical slot 22 and flange 24 are constructed out of a single piece of material, with the brush 26 secured inside the elongated vertical slot 22. The bracket system 20 includes two clamps 28 which are capable of being secured to the flange 24 through the bolt 30a and nut 30b which are placed through the clamp apertures 38 and the flange aperture 34. When the bracket system 20 is not attached to the non-linear mower blade 12, each of the two clamps 28, and the bolts 30a and nuts 30b, and the brush attachment 21 are separate pieces.

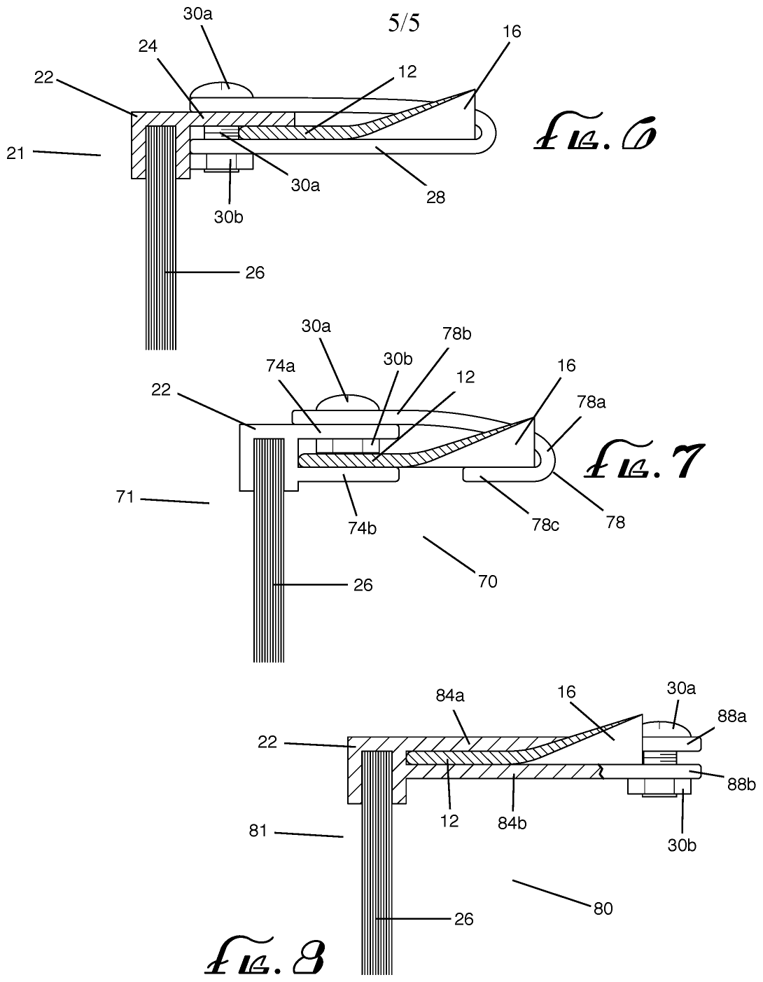

FIGS. 7 and 8 depict alternate embodiments of the bracket system 20 wherein the brush attachment has more than one flange to secure the brush attachment to the non-linear mower blade 12. The concept of positioning at least one clamp in a location on the non-linear mower blade 12 such that at least one clamp sits adjacent to the non-linear portion of a non-linear mower blade 12 in order to provide a bracing surface for at least one of the clamps to resist the centrifugal force 18 caused by the rotation 14 of the non-linear mower blade 12 remains constant throughout each alternative embodiment. Thus, each alternative embodiment illustrates an alternative way of removably attaching a bracket system to a non-linear mower blade 12 in the same location as the preferred embodiment.

FIG. 7 depicts a bracket system 70 including a brush attachment 71, hook clamp 78, and fastening device. The brush attachment 71 includes an elongated vertical slot 22, brush 26, top flange 74a, and bottom flange 74b. The top flange 74a and the bottom flange 74b may either be attached to the elongated vertical slot 22, or the top flange 74a, bottom flange 74b, and elongated vertical slot 22 may be manufactured out of a single piece of material. The hook shape of the hook clamp 78 is defined as a piece of material with a curved portion 78a with a first leg portion 78b and second leg portion 78c extending from the curved portion 78a, where the first leg portion 78b is greater in length than the second leg portion 78c. The hook clamp 78 includes a hook clamp aperture located at the end of the first leg portion 78b. The top flange 74a includes a flange aperture configured to align with the hook clamp aperture and receive the fastening device. The non-linear mower blade 12 is inserted into the gap between the top flange 74a and the bottom flange 74b, and the hook clamp 78 is positioned around the non-linear mower blade 12 such that the second leg portion 78c sits below the non-linear mower blade 12. The gap between the top flange 74a and bottom flange 74b is large enough to accept a non-linear mower blade 12 and at least a portion of the fastening device.

In the alternative embodiment depicted in FIG. 7, the fastening device is a bolt 30a and nut 30b. The bolt 30a is placed through the hook clamp aperture and top flange aperture, and the nut 30b tightens onto the bolt 30a, thereby removably securing the top flange 74a of the brush attachment 71 to the hook clamp 78. The gap between the top flange 74a and the bottom flange 74b is large enough for the nut 30b and the non-linear mower blade 12 to fit inside, while being small enough so when the nut 30b is tightened to the bolt 30a, the non-linear mower blade 12 is securely held between the top flange 74a and bottom flange 74b. Thus, when the hook clamp 78 is positioned around the non-linear mower blade 12 and the hook clamp is secured to the top flange 74a of the brush attachment 71 by the bolt 30a and nut 30b, the bracket system 70 is removably attached to the non-linear mower blade 12.

FIG. 8 depicts a bracket system 80 including a brush attachment 81 and fastening device. The brush attachment 81 includes an elongated vertical slot 22, brush 26, top flange 84a, bottom flange 84b, top flange clamp 88a, and bottom flange clamp 88b. The top flange 84a and the bottom flange 84b may either be attached to the elongated vertical slot 22, or the top flange 84a, bottom flange 84b, and elongated vertical slot 22 may be manufactured out of a single piece of material. The top flange 84a and top flange clamp 88a are preferably flush together, and may either be constructed of a single piece of material, or the top flange clamp 88a may be attached to the top flange 84a. Similarly, the bottom flange 84b and bottom flange clamp 88b are preferably flush together, and may either be constructed of a single piece of material, or the bottom flange clamp 88b may be attached to the bottom flange 84b. The gap between the top flange 84a and top flange clamp 88a, and the bottom flange 84b and bottom flange clamp 88b, is configured to allow the insertion of the non-linear mower blade 12.

The length of the top flange 84a and top flange clamp 88a is greater than the width of the non-linear mower blade 12. Similarly, the length of the bottom flange 84b and bottom flange clamp 88b is greater than the width of the non-linear mower blade 12. The portion of the top flange clamp 88a that extends beyond the inserted non-linear mower blade 12 includes a top aperture. Likewise, the portion of the bottom flange clamp 88b that extends beyond the inserted non-linear mower blade 12 includes a bottom aperture. The top aperture and bottom aperture are configured to be aligned and receive the fastening device.

The preferred fastening device for the alternative embodiment depicted by FIG. 8 is a bolt 30a and nut 30b. The bolt 30a is placed through the top aperture and bottom aperture, and the nut 30b is then tightened onto the bolt 30a. The top aperture and bottom aperture are positioned such that the bolt 30a may be inserted through the top aperture and bottom aperture without being placed through the non-linear mower blade 12. The nut 30b is tightened onto the bolt 30a, thereby removably securing the brush attachment 81 to the non-linear mower blade 12. Thus, the bracket system 80 is removably attached to the non-linear mower blade 12.

While the invention has been described in terms of a preferred embodiment, it is to be understood that the words that have been used are words of description and not of limitation. As is understood to persons of ordinary skill in the art, a variety of modifications can be made without departing from the scope of the invention defined by the following claims, which should be given their fullest, fair scope.

I claim:

1. A bracket system for connecting a brush to a non-linear blade of a lawn mower having a bracing surface, the bracket system comprising:
a brush;
a brush attachment having an elongated vertical slot for receiving said brush;
a flange secured to said vertical slot, said flange having at least one aperture;
at least one clamp having apertures for aligning with said aperture of flange;
at least one fastening means passing through said apertures of said clamp and said flange; and
wherein said at least one clamp removably fastens to said flange about said non-linear mower blade in a position in which said clamp can engage said bracing surface of said blade.

2. The bracket system of claim 1, wherein said fastening means is configured to removably fasten said at least one clamp to said flange.

3. The bracket system of claim 2, wherein said fastening means is a bolt and nut.

4. The bracket system of claim 1, wherein said at least one clamp includes a gap, wherein said gap is greater than or equal to the depth of said flange and said blade of a lawn mower.

5. The bracket system of claim 4, wherein the depth of said flange is equal to the depth of said blade of a lawn mower.

6. The bracket system of claim 4, wherein said flange and said blade of a lawn mower are configured to be inserted into said at least one clamp.

7. The bracket system of claim 1, wherein said brush is made of nylon.

8. The bracket system of claim 1, wherein said elongated vertical slot and said flange are constructed of a single piece of material.

9. A bracket system for connecting a brush to a non-linear blade of a lawn mower having a bracing surface, the bracket system comprising:
a brush attachment, wherein said brush attachment comprises:
a brush,
an elongated vertical slot, wherein said elongated vertical slot has two vertical legs extending from a horizontal base, and
a flange, wherein said flange extends outwardly from said horizontal base of said elongated vertical slot, and wherein said flange has at least two apertures;
at least two clamps, wherein each of said at least two clamps have two parallel legs extending from a base, wherein said two parallel legs are configured to surround the blade of a lawn mower and engage said bracing surface of said blade, and wherein the length of each of said two parallel legs is greater than the width of said blade of a lawn mower; and
a bolt and nut;
wherein said brush is affixed to said elongated vertical slot by attaching said brush to said horizontal base between said two parallel vertical legs;
wherein each of said two parallel legs of said at least two clamps have an aperture in the portion of said two parallel legs extending beyond said blade of a lawn mower,
wherein said blade of a lawn mower and said flange are the same depth;
wherein said blade of a lawn mower and said flange are inserted into said at least two clamps such that said apertures of said two parallel legs align with said at least two apertures of said flange; and
wherein said bolt runs through the aligned apertures of said two parallel legs and apertures of said flange, and said nut screws onto said bolt, thereby attaching said brush attachment to said blade of a lawn mower.

10. A method of removably attaching a bracket system to a non-linear blade of a lawn mower having a bracing surface, the improved method comprising:
placing a brush attachment adjacent to said blade of a lawn mower, wherein said brush attachment comprises a brush, an elongated vertical slot, and a flange having at least one aperture;
positioning a clamp having apertures about said blade to permit said clamp to engage said bracing surface;
inserting said flange into said clamp after said clamp is positioned about said blade;
aligning said apertures of said flange with said apertures of said clamp; and
fastening said clamp to said flange with a fastening means through said apertures.

11. The method of claim 10, further comprising removing said clamp from said flange, thereby removing said brush attachment from said blade of a lawn mower.

12. The method of claim 10, wherein said clamp comprises at least two clamp apertures.

13. The method of claim 10, wherein said fastening means is a bolt and nut.
